(19) United States
(12) Patent Application Publication
(10) Pub. No.: US 2025/0383204 A1
(43) Pub. Date: Dec. 18, 2025

(54) GYROSCOPE USING POLARIZATION MEASUREMENT OF LIGHT OR RADIO WAVES AND ASSOCIATED SYSTEMS AND METHODS

(71) Applicant: Fermi Forward Discovery Group, LLC, Chicago, IL (US)

(72) Inventors: Surjeet Rajendran, Ellicott City, MD (US); David E. Kaplan, Baltimore, MD (US); Michael Fedderke, Kitchener (CA); Francesco Serra, Baltimore, MD (US); Roni Harnik, Chicago, IL (US); Sam Posen, Chicago, IL (US); Vyacheslav P. Yakovlev, Chicago, IL (US)

(21) Appl. No.: 19/242,422

(22) Filed: Jun. 18, 2025

Related U.S. Application Data
(60) Provisional application No. 63/661,522, filed on Jun. 18, 2024.

(51) Int. Cl. G01C 19/64

(52) U.S. Cl. CPC G01C 19/64

(57) ABSTRACT

A gyroscope that measures the effects of rotation on the polarization of light. Rotation induces a differential phase shift in the propagation of left- and right-circularly polarized light as measured in the gyroscope. A beam splitter splits a linearly polarized beam into two polarized light waves, which are sent to a respective polarizer that converts and forwards the left- and right-circularly polarized light waves into respective cavities each axially aligned with a common axis of rotation. The signal is independent of the frequency of light. Noise sources such as vibrations, which cause phase shifts that depend on the frequency, are mitigated by simultaneously using two (or more) sources of light having different frequencies. The signal scales with the total storage time of the light within cavities and may be measured using superconducting radio-frequency systems where the high finesse of the available cavities enables considerably longer storage times in optical setups.

### CROSS-REFERENCE TO RELATED APPLICATIONS

This application is related to and claims the benefit under 35 U.S.C. § 119(e) of U.S. Provisional Patent Application Ser. No. 63/661,522 filed by the inventors of the present application on Jun. 18, 2024 and titled GYROSCOPE USING POLARIZATION MEASUREMENT OF LIGHT OR RADIO WAVES AND ASSOCIATED SYSTEMS AND METHODS, the entire contents of which are incorporated herein by reference.

### STATEMENT REGARDING FEDERALLY SPONSORED RESEARCH OR DEVELOPMENT

The invention described in this patent application was made with Government support under the Fermi Research Alliance, LLC, Contract Number DE-AC02-07CH11359 and the follow-on Fermi Forward Discovery Group, LLC, Contract Number 89243024CSC000002, both awarded by the U.S. Department of Energy. The Government has certain rights in the invention.

### FIELD OF THE INVENTION

The present invention relates generally to the field of measurement of rotational motion and, more particularly, to systems and methods for measuring rotation using light while distinguishing between rotations and vibrations in measuring components.

### BACKGROUND OF THE INVENTION

Precision gyroscopes have many important uses, ranging from inertial navigation to fundamental physics applications such as tests of General Relativity. Various precision techniques have been developed to measure rotations. For example, certain known gyroscope designs are based on the measurement of nuclear spin precession, which is subject to magnetic field noise. Other known designs are based on the Josephson effect as observed in superfluid helium quantum interference devices (SHeQUIDs). Still more known designs are based on Sagnac interferometers (either optical or atomic).

More specifically, in known designs that use the Sagnac effect to measure rotation using light, the rotation manifests as a length change. In that case, the phase shift is directly proportional to the frequency of light. A key limitation of gyroscopes based on the Sagnac effect is vibration of the mirrors used in the setup. Such vibrations cause relative length changes in the apparatus which lead to phase shifts that are also directly proportional to the frequency of light, preventing the system from distinguishing between rotations and vibrations (a phenomenon referred to herein as vibrational noise).

Although certain advances in the state of the practice have been made toward analysis of the polarization of optical light to measure rotations, radio frequency (RF) light presents a promising alternative to optical light because RF light may be stored for longer periods compared to optical light, potentially resulting in significantly enhanced sensitivity. The critical issue of vibrational noise cancellation remains largely unaddressed.

For example, mitigation of vibrational noise is an area of significant research activity in inertial navigation systems (INS) design. Known INS technologies commonly suffer from drift errors (i.e., small errors from sensors such as accelerometers and gyroscopes used to provide navigation-enabling information). If such small errors are allowed to accumulate over time, the resultant drift may compromise accurate navigation in Global Positioning System (GPS)-denied environments. Even less severe vibrational noise, when experienced under poor INS conditions, may dramatically degrade INS solution quality. Such vibration may cause perturbations in position, velocity, and acceleration, which are precisely the states that a typical INS design is trying to estimate.

Accordingly, a need exists for a solution to at least one of the aforementioned challenges in design for measurement of rotational motion. More specifically, a need exists for devices, systems and methods for mitigating magnetic field noise when measuring rotation using spins and/or vibrational noise when measuring rotation using light. These are features and capabilities of the present invention as disclosed and claimed, which provides solutions to the multiple shortcomings of prior art inventions in this field.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to design, implementation, and/or operation of a rotation measurement system for a rotating body characterized by an axis of rotation. The rotation measurement system may comprise 1) a first light source; 2) a sending beam splitter; 3) a first sending polarizer and a second sending polarizer; 4) a first cavity and a second cavity each characterized by a length L and a finesse F and each substantially axially aligned with the axis of rotation; 5) a first receiving polarizer and a second receiving polarizer; 6) a receiving beam splitter; and 7) a detector. The first light source may be employed to radiate a linearly polarized beam (e.g., of an optical frequency type or a radio frequency (RF) type). The sending beam splitter may split the linearly polarized beam into a first linearly polarized light wave and a second linearly polarized light wave.

The first sending polarizer may convert the first linearly polarized light wave to a first right-circular polarized state (i.e., a right-circularly polarized light wave); and the second sending polarizer may convert the second linearly polarized light wave to a second left-circular polarized state (i.e., a left-circularly polarized light wave). The first cavity may store the right-circularly polarized light wave for a storage time ˜FL while the second cavity simultaneously may store the left-circularly polarized light wave for the storage time ˜FL. The first receiving polarizer may receive the right-circularly polarized light wave from the first cavity after the storage time ˜FL and may convert the right-circularly polarized light wave to a first linearly polarized received wave; while the second receiving polarizer may receive the left-circularly polarized light wave from the second cavity after the storage time ˜FL and may convert the left-circularly polarized light wave to a second linearly polarized received wave. A receiving beam splitter may combine the first and second linearly polarized received waves into an interfered beam. The detector may detect in the interfered beam a differential phase shift ΔΦ. The differential phase shift ΔΦ may comprise a vibrational noise component of the rotating body. Advantageously, this differential phase shift ΔΦ may be sensitive to rotation of the measured rotating body but may be free of noise associated with the light source such as, for example, and without limitation, phase and frequency noise.

More specifically, the differential phase shift ΔΦ may comprise a vibrational noise component arising from vibrations of the various elements of the system such as the mirror elements of the cavities and the polarizers. To mitigate these, the first light source may simultaneously produce light containing multiple different frequency components. This light containing multiple frequency components may undergo the processes described above (such as splitting into a first and second beam, sending polarization, storage in a cavity, receiving polarization, recombination to produce an interfered beam, detection of relative phase between beams) with all the processes performed using the same cavity elements, polarizers and beam splitters. Suitable linear combinations of the differential phase measured using the different frequency components of the two beams is sensitive to the rotation but is free of the vibrational noise component.

In certain embodiments of the present invention, the first light source may be configured to emit more than one linearly polarized beam, each of a differing frequency of light and to each of which the measurement process described hereinabove may be advantageously applied. In other embodiments of the present invention, the first light source may be employed along with a second light source that may radiate a second linearly polarized beam of a different frequency than that of the linear polarized beam of the first light source. To each of the first and second linearly polarized beams, the measurement process described hereinabove may be advantageously applied.

In certain embodiments of the present invention, where the linearly polarized beam employed is of the RF type, the first cavity and the second cavity each may be of a superconducting RF cavity type. Where the linearly polarized beam employed is of the optical frequency type, the first cavity and the second cavity may each be of a Fabry-Perot cavity type and/or the detector may be of an optical interferometer type. Alternatively, or in addition, any or all of the first sending polarizer, the second sending polarizer, the first receiving polarizer, the second receiving polarizer may be of a quarter-wave plate type.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawing provided to illustrate and not to limit the invention, where like designations denote like elements, and in which:

FIG. 1 is a schematic diagram depicting an exemplary precision gyroscope architecture according to an embodiment of the present invention.

Like reference numerals refer to like parts throughout the several views of the drawings.

### DETAILED DESCRIPTION OF THE INVENTION

The present invention will now be described more fully hereinafter with reference to the accompanying attachments, in which preferred and alternative embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those of ordinary skill in the art.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

As used herein, the word “exemplary” or “illustrative” or “shown” means “serving as an example, instance, or illustration.” Any implementation described herein as “exemplary” or “illustrative” is not necessarily to be construed as preferred or advantageous over other implementations. All of the implementations described below are exemplary implementations provided to enable persons of ordinary skill in the art to make or use the embodiments of the disclosure without undue experimentation or a degree of experimentation beyond that which is customary in the art, and are not intended to limit the scope of the disclosure, which is defined by the claims.

Systems and associated methods for measuring rotation according to embodiments of the present invention are now described in detail. Throughout this disclosure, the present invention may be referred to as a rotation measurement system or method; an electromagnetic wave gyroscope system or method; a method of measuring rotation; a gyroscope; a system; and/or a method. Those skilled in the art will appreciate that this terminology is only illustrative and does not affect the scope of the invention.

Certain embodiments of the present invention may comprise systems and/or methods for measuring rotation by looking for the effects of that rotation on the polarization of light. The basic physical principle behind this measurement scheme is as follows: Rotation changes the dispersion relation of circularly polarized light, leading to a differential shift in the dispersion relation for left- and right-circularly polarized light. This shift leads to a relative phase between suitably stored right- and left-circularly polarized light, which can be measured precisely using interferometry. An advantage of this method of measurement, as described in detail hereinbelow, is that the phase shift is independent of the frequency of light. Instead, the phase shift depends only on the rotation rate and the time for which the light is stored (unlike known gyroscopes based on the Sagnac effect). In the measurement systems and methods described hereinbelow, the phase shift caused by polarization may be independent of the frequency of the light whereas phase shifts arising from vibrations may be directly proportional to the frequency. Due to this difference, embodiments of the present invention may employ two frequencies of light to measure simultaneously, advantageously breaking the degeneracy between the signal from rotation and the noise from vibration. That is, because rotations and vibrations cause phase shifts that scale differently with frequency, the phase-shift difference between the two frequencies may be used to measure and subtract out vibrations, giving access to the signal from rotations that is common to both frequencies.

The independence of the signal on the frequency of light also implies that the signal is the same whether a gyroscope so designed employs optical or radio frequencies (rf) to measure the signal. Because the signal also scales with the storage time of the light, it is advantageous to use radio frequency light for this measurement given that these frequencies may be stored for considerably longer periods of time (for example, and without limitation, in superconducting cavities) than optical light. Certain embodiments of the present invention, as described hereinbelow, consider the use of suitably designed rf cavities to detect this effect, although the same technique may be used at optical frequencies, but with reduced overall sensitivity.

### I. Signal

As a matter of definition, computation of the effect of rotation on the polarization of light may be described by the following example scenario: Given a system rotating around a z axis with a rotation rate Ω, assume that from the origin a left- or right-circularly polarized light is transmitted along the z axis. The effect of rotation on polarization may be analyzed for such a system first in the rotating frame. In this frame, the metric that describes the system is as follows (Equation (1)):

$${ds}^{2} = [ - 1 + {Ω}^{2} ( {x}^{2} + {y}^{2} ) ] {dt}^{2} - 2 Ω ydtdx + 2 Ω xdtdy + {dx}^{2} + {dy}^{2} + {dz}^{2} . \qquad ( 1 )$$

Working in the Weyl gauge A₀=0, consider the propagation of two electromagnetic waves with vector potentials as shown in Equation (2):

$${( {A}_{\pm } )}_{μ} = {𝒜}_{\pm }^{0} {e}^{i ( ω t - {k}_{\pm } z )} [ 0 , 1 , \pm i , {A}_{z} ( t , x , y , z ) ] , \qquad ( 2 )$$

where [symbol] correspond, respectively, to right-(−) and left-(+) circularly polarized light. Note: Given sign conventions used herein, the left and right definitions for handedness match those seen by the emitter. Here, A_{z}=±iΩ(x±iy), which vanishes in the limit x→0, y→0 (appropriate when the transverse size of the light beam is small compared to 1/Ω). Waves of the form at Equation (2) are solutions to the vacuum Maxwell equations that have the following dispersion relations (Equation (3)):

$${k}_{\pm } = ω ∓ Ω . \qquad ( 3 )$$

Note: See Section IV for a derivation of this Equation (3) result. Equation (3) shows that right- and left-circularly polarized light will travel with different wave numbers k_{±}. If the waves travel for a distance L, the differential phase between the right- and left-circularly polarized light will be ΩL, independent of the frequency ω of the light. Note: See Section V for discussion of more general orientations for the rotation with respect to the propagation direction of the light.

Considered in an inertial frame, the result of Equation (3) describes that the propagation of the light is unaffected by the rotation because the light simply moves in Minkowski space. However, the source of the polarized light is rotating in this frame, which leads to a continually increasing relative phase between the propagating light and the polarization axis of the source that produces the light. The signal is thus similar to that which arises in nuclear spin gyroscopes. In such known gyroscope designs, the nuclear spins act as an inertial reference, with their orientation unaffected by rotation. However, rotation causes the sensing apparatus to rotate, resulting in a relative rotation between the spin and the measuring apparatus. Similarly, in the case of the signal of embodiments of the present invention, the polarized states of the light act as inertial references. The signal then arises due to the relative rotation between this inertial reference and the rotating apparatus used to produce or detect the polarized light.

### II. Setup

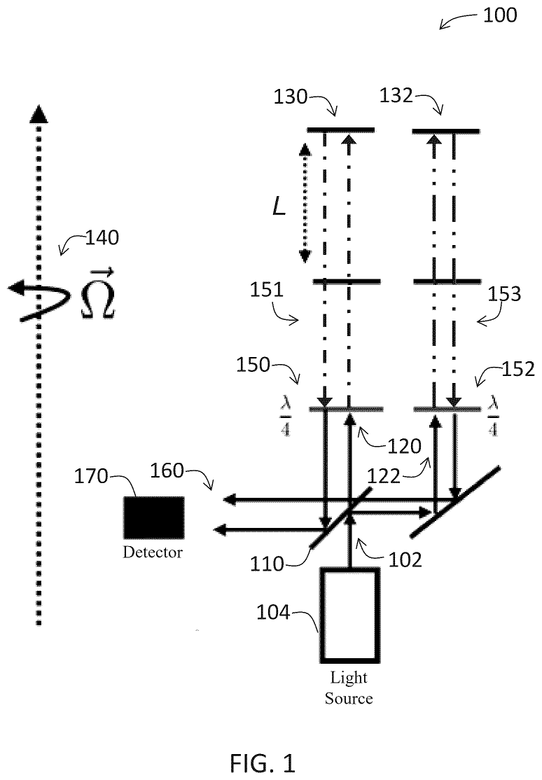

Certain embodiments of the present invention may employ a measurement scheme to detect the effect described in Section II in a suitably designed Fabry-Pérot cavity. For example, and without limitation, the shift (from Equation (3)) in the wave number caused by the rotation may be measured by converting it into a phase. To maximize this phase, the light may be advantageously exposed to the rotation for as long as possible. To achieve this in a compact device, the light may be required to be held in a cavity of some kind. Further, a measurement scheme may need to significantly suppress dominant sources of noise such as frequency and phase noise in the light, as well as systematics that may arise from vibrations in the cavity. Such considerations may be advantageously addressed by the exemplary rotation measurement system setup 100 illustrated in FIG. 1. As shown, linearly polarized light 102 as transmitted by a light source 104 may be directed through a suitable polarization apparatus 110 (e.g., sending polarizer) which may split the beam into left-(single-dotted arrow 151) and right-(double-dotted arrow 153) circularly polarized beams. These beams 151, 153 may be stored, respectively, in two Fabry-Pérot cavities 130, 132 that are both aligned with an axis 140 of rotation \vec{Ω}. The differential phase between these two beams 151, 153 may be free of phase and frequency noise from the light source 104, but may retain the rotation signal.

More specifically, the two Fabry-Pérot cavities 130, 132 each may be of length L and finesse F. The cavities are aligned along the direction of rotation \vec{Ω}. After producing linearly polarized light 102 from a suitable source 104, this light 102 may be split and one part 120 of the light may be sent to a suitable optical element 150 (e.g., a quarter-wave (λ/4) plate] which may convert that first light 120 to left-circularly polarized light 151 while the other part 122 may be sent to a second optical element 152 (e.g., a different quarter-wave plate) that may convert that second light 122 to right-circularly polarized light 153. The two beams 151, 153 may be sent to two different Fabry-Pérot cavities 130, 132 where the beams 151, 153 are stored for a time ˜FL. After this time, the beams 151, 153 may be sent back through the same respective quarter-wave plates 150, 152 and recombined. The interfered beam 160 may be detected at a detector 170.

In such a system configuration, the wave numbers of the left- and right-circularly polarized light 151, 153 may experience different shifts. This difference may manifest as a relative phase shift between these two beams 151, 153 when they are reinterfered 160. A design objective of the system 100 is for the signal in this setup to scale with FL, the total time for which the light 151, 153 is held in the cavity 130, 132. If the mirrors of the cavity 130, 132 are made with conventional reflecting surfaces, the overall phase of the electromagnetic vector potential (A_{±})_{μ} changes by π upon reflection. But, the reflection does not cause a relative phase between the x and y components of (A_{±})_{μ}. It can then be shown that for the reflected wave also the wave numbers are k_{±}=ω∓Ω. Thus, the phase accumulated by the light will continually add. In other words, while left-(right-) circularly polarized light 151, 153 becomes right-(left-) circularly polarized upon reflection, since the direction of the light has also changed, the effect of the rotation on the wave number remains the same. Note: The situation is thus similar to the accumulation of phase for light stored in a cavity in the presence of a static axion gradient, as opposed to a long-period time-dependent dark-matter axion field for which the phase accumulation cancels out when employing conventional mirrors in the cavity. Another way to describe the continual addition of phase regardless of the direction of travel of the light in the cavity is that the flip of left to right handedness (and vice versa) of the light upon reflection off the mirrors is a helicity flip that occurs because the linear momentum of the light changes sign but the angular momentum does not. Because the relative orientation of the angular momentum of the light and that of the rotation of the cavities is, however, unchanged after the bounce off the mirror, the phase shift to the light induced by the rotation continues to add for trips in either direction in the cavity.

The phase shift between the two arms of the interferometer 100 may be calculated as follows (Equation (4)):

$$ΔΦ \sim \frac{4 F}{π} Ω L . \qquad ( 4 )$$

In general, this signal may be either larger or smaller by a factor of O(1) depending on choices made for the relative cavity 130, 132 orientations and on the orientation of the rotation axis 140 with respect to the cavity orientation. Notice that since the phase shift ΔΦ is a differential phase, that shift is free of frequency and phase noise inherent to the light source 104. Relative motions of the mirrors of the cavity 130, 132 will also cause uncanceled phase shifts in this setup. But, crucially, the phase shift caused by a relative length shift δL is ωδL, where ω is the frequency of the light 102. This is frequency dependent, unlike Equation (4) which is frequency independent. Because low-frequency vibrations are a limiting source of noise for conventional Sagnac gyroscopes, the potential advantage of the measurement scheme of the embodiments of the present invention is therefore demonstrated: one may operate the entirety of the above setup with two different frequencies of light simultaneously. Because the phase shifts from the rotational signal and vibrational noise scale differently with the frequency of the light, embodiments of the design described herein may use the difference between the phase shifts at the two frequencies as an effective measurement of the vibrations in the system, allowing that difference to be subtracted off and providing access to the common phase shift between the two frequencies that encodes the rotation rate Ω.

The setup described hereinabove may be implemented with a variety of light sources, whether optical or rf. However, using rf sources instead of optical light may provide a distinct advantage. The signal of Equation (4) is independent of the frequency ω of the light and only depends on the storage time FL of the light. Due to the existence of ultra-high-finesse superconducting rf cavities, rf light may be stored for considerably longer periods than optical light. From this perspective, realize this setup using rf rather than optical sources may thus be advantageous. A disadvantage of the rf source may be that the longer wavelength of the rf light may require larger mirrors for the cavities to combat diffractive losses and, thus, gyroscopes using rf light may be less desirable in applications for which the compactness of the device is a significant design constraint.

### III. Sensitivity

The fundamental sensitivity achievable employing the design approach introduced in Section II, the reach of this scheme may be compared to that of the conventional Sagnac scheme. The fundamental limit on the sensitivity of certain embodiments of the present invention may be set by the shot-noise limit on the resolution of the phase shift (signal) of Equation (4). This limit yields the following (Equation (5)):

$${( Ω \sim 10 )}^{- 11} \frac{Hz}{\sqrt{Hz}} ( \sqrt{\frac{{10}^{9}}{F}} ) ( \frac{1 m}{L} ) \sqrt{\frac{1 MW}{{P}_{max}}} \sqrt{\frac{ω}{2 π \times 10 GHz}} \qquad ( 5 )$$

for a device operating with a circulating power Pₘₐₓ. Fiducial parameters suitable for superconducting rf cavities are assumed in this estimate. Note that the required input power to the cavity is only ˜Pₘₐₓ/F˜1 mW×(Pₘₐₓ/1 MW)×(10⁹/F). In the estimate at Equation (5), a finesse of F˜10⁹ is assumed. For reasons related to rf cavity control at such high finesse, this may be an aggressive assumption. A more conservative assumption may be F˜10⁷, for which cavity control requirements are significantly relaxed. This relaxed assumption would, however, only degrade the sensitivity estimate at Equation (5) by one order of magnitude, and the input power required would still only be ˜0.1 W.

The theoretical fundamental sensitivity of the described device may thus be greater than the demonstrated sensitivities

$$\sim {10}^{- 8} \frac{Hz}{\sqrt{Hz}}$$

of terrestrial gyroscopes known in the art that are constructed with optical or atom interferometers in the Sagnac configuration, or nuclear-spin-based gyroscopes.

Given this limit, of interest is comparing the sensitivity of the design introduced in Section II to the theoretical sensitivities of the Sagnac setup. In the Sagnac configuration, where the arm lengths of the setup are L, the phase shift is defined as in Equation (6):

$${ΔΦ}_{S} \sim F ωΩ {L}^{2} , \qquad ( 6 )$$

assuming for the purposes of comparison that the Sagnac configuration is operating such that the light completes N˜F loops around the Sagnac ring before being read out. Comparing Equation (6) to Equation (4), the conventional Sagnac phase shift is shown to be parametrically a factor of ωL larger than the polarization phase shift of the design described herein. For optical light, ωL>>1 is typical for a macroscopic cavity. For rf, ωL is typically not as large, leading to a smaller parametric enhancement for an rf Sagnac configuration.

Interpreting his result with nuance and care, while it is true that a Sagnac interferometer has a fundamental shot-noise limited sensitivity that, for the same assumed parameters, is parametrically enhanced as compared to the design described herein, most practical Sagnac interferometers are limited not by their shot-noise floor, but instead by vibrational noise sources that cannot even in principle be distinguished by the signal of rotation. To understand why this is the case, consider that in a typical Sagnac configuration, light propagates in two different directions along a closed loop. Rotation causes one of these paths to be longer than the other, resulting in a phase-shift signal that is proportional to the frequency ω of the light. In the absence of rotation, suppose one of the optical elements in the Sagnac interferometer instead experiences a low-frequency vibrational motion. Because the light rays traverse the Sagnac loop along different directions, these rays experience the position of this vibrating optical element at slightly different times. This phenomenon results in an uncommon length difference between the two light paths, leading to a phase shift that is also proportional to the frequency of the light, ω. In a such a Sagnac setup, therefore, distinguishing a signal of rotation from a vibration of the optical elements becomes problematic; vibrations effectively constitute an irreducible noise floor.

By contrast, various embodiments of the present invention make it possible to distinguish vibrational noise of the optical elements from the rotation signal. For example, and without limitation, two different (cavity-resonant) frequencies of light may be employed simultaneously in making the measurement described in the design of the present invention. By considering all light arriving at the interferometric readout at a given time then (assuming the finesse is flat with frequency) all its frequency components will have always followed the same optical path in the apparatus, and will thus have encountered the same stochastically vibrating optical elements everywhere in the optical path at the same times. The implication is that all frequencies will experience a common (although stochastic over time) length fluctuation of the two cavities during the time the light resides in the apparatus. This common length fluctuation may, however, give rise to different, although proportional, phase shifts at each light frequency. However, the rotation signal of Equation (4) in the described setup is independent of the light frequency. Therefore, in principle, it is possible to distinguish the phase noise arising from vibrations of optical elements from a true rotation signal in the described measurement: the vibrational signal shows up in the differential phase shift between the two frequencies, and may be subtracted off to expose the rotationally induced phase that is common to both (or all) frequencies. This ability of certain embodiments of the present invention to ameliorate vibrational noise may thus advantageously enable gyroscopes so designed to achieve greater sensitivity in practice than is achievable with the Sagnac configuration.

A potentially important systematic issue that may prevent the gyroscope design described herein from achieving the fundamental sensitivity per Equation (4) is that of potential shifts to the polarization vector of the light whenever the light reflects from the mirror. This effect may scale with the finesse F, but it is independent of the cavity length L. This is unlike the signal from the rotation which scales with L. Given this difference, mitigation of the effects of such a shift may, in principle, be possible. For example, and without limitation, a gyroscope as described herein may be operated with various cavity lengths and using the difference in the functional dependence of the signal and this systematic to calibrate this effect out. With such a calibration, the systematic could still affect this measurement if there is a time-dependent contribution to this polarization shift, leading to a change in the magnitude of the effect between the calibration and the operation of the device. It is reasonable to expect that in a superconducting rf setup, the cause of such a polarization shift may be due to mechanical imperfections in the mirrors themselves and that these imperfections are likely to be static. It is thus reasonable that the time dependence of these shifts may be small, but this question may need to be carefully studied under realistic experimental conditions.

In various applications of certain embodiments of the present invention, operation of such a light-based gyroscope may advantageously be employed as a final fine-measurement stage. Such a gyroscopic assembly may be mounted on a set of nulling gimbals designed to cancel most of the gross rotational motion of the platform being monitored. The description hereinabove analyzes only rotational motion oriented around the axis of the light propagation, because large rotational motion around another axis may induce additional phase shifts and phase gradients across cavity mirrors that may complicate the analysis. If fine measurement along multiple axes is required, either a set of orthogonal light gyroscopes may be used, or the additional phase shifts induced by rotation about an axis different from the cavity symmetry axis may need to be understood in more detail. See also Section V for further detail.

Moreover, it is likely that, in order to impute the high degree of rotational measurement precision made available by the light gyroscope design of the present invention to a measurement of the platform whose rotational state is desired to be known, either an extremely rigid set of mounts to the platform may be required or, alternatively, active metrology and feedback may be needed to measure and control for any relative motion of the gyroscope assembly and the platform due to, for example, vibrations.

Embodiments of the present invention are directed to accurate detection of small rotations (e.g., a gyroscope). In general, embodiments of the present invention exploit the phenomenon of rotation affecting the polarization of light in a frequency independent manner, unlike the effects of vibrational (and many other) noise sources that are frequency dependent. By utilizing light of multiple frequencies to make independent measurements of the polarization state of each frequency, there exist suitable combinations of these measurements which only contain the rotation component without vibrational components.

For example, and without limitation, radio waves of known polarization may be stored in a cavity system. When the entire system rotates, the polarization of the radio waves will rotate. Precision measurement of this polarization may be achieved using interferometry, resulting in a highly precise sensor of rotations. Advantageous use of this technology may be employed, for example, and without limitation, in precision inertial navigation.

Also for example, and without limitation, outlined herein is a protocol that may measure rotation through its effects on the polarization of light. The independence of the rotation signal on the frequency of light enables such a setup to potentially combat systematics arising from vibrational noise that confront typical Sagnac-style interferometric measurements of rotation. Further, the frequency independence of the signal also means that one may measure this signal using high-finesse rf systems where the long storage time of the light may significantly enhance the sensitivity of the apparatus.

### Section IV: Rotations Around the \hat{z} Axis

Described hereinbelow is an explicit derivation of a solution for a plane wave in the rotating frame (more specifically, derivation of the results of Equations (2) and (3) hereinabove). Considering Maxwell's equations in a frame rotating around the \hat{z} axis \vec{Ω}=(0,0,Ω), Equation (A1) illustrates the following metric:

$${g}_{μ v} {dx}^{μ} {dx}^{v} = [ - 1 + {Ω}^{2} ( {x}^{2} + {y}^{2} ) ] {dt}^{2} - 2 Ω dt ( xdy - ydx ) + {dx}^{2} + {dy}^{2} + {dz}^{2} . \qquad ( A1 )$$

Maxwell's equations are represented by ∇_{μ}F^{μv}=0, where ∇_{μ} is a covariant derivative with respect to g_{μv}. Looking for plane-wave solutions propagating along z, pick Weyl gauge and take the following ansatz for the vector potential (Equation (A2)):

$${A}_{μ} = ( 0 , {A}_{x} ( z , t ) , {A}_{y} ( z , t ) , {A}_{z} ( x , y , z , t ) ) . \qquad ( A2 )$$

As shown, this ansatz solves Maxwell's equations in the rotating frame. Indeed, computing ∇_{μ}F^{μv}=0 produces the following (Equation (A3)):

$${\partial }_{t} {\partial }_{z} {A}_{z} + Ω [ {\partial }_{z}^{2} ( {xA}_{y} - {yA}_{x} ) + ( y {\partial }_{x} - x {\partial }_{y} ) {\partial }_{z} {A}_{z} ] = 0 , ( {\partial }_{t}^{2} - {\partial }_{z}^{2} ) {A}_{x} + {\partial }_{x} {\partial }_{z} {A}_{z} = Ω ( {\partial }_{t} {A}_{y} + y {\partial }_{t} {\partial }_{z} {A}_{z} ) + {Ω}^{2} [ xy {\partial }_{z} ( {\partial }_{z} {A}_{y} - {\partial }_{y} {A}_{z} ) - {y}^{2} {\partial }_{z} ( {\partial }_{z} {A}_{x} - {\partial }_{x} {A}_{z} ) ] , \qquad ( A3 )$$

$$( {\partial }_{t}^{2} - {\partial }_{z}^{2} ) {A}_{x} + {\partial }_{x} {\partial }_{z} {A}_{z} = - Ω ( {\partial }_{t} {A}_{x} + x {\partial }_{t} {\partial }_{z} {A}_{z} ) + {Ω}^{2} [ xy {\partial }_{z} ( {\partial }_{z} {A}_{x} - {\partial }_{x} {A}_{z} ) - {x}^{2} {\partial }_{z} ( {\partial }_{z} {A}_{y} - {\partial }_{y} {A}_{z} ) ] ,$$

$$( {\partial }_{t}^{2} - {\partial }_{x}^{2} - {\partial }_{y}^{2} ) {A}_{z} - Ω {\partial }_{t} [ {\partial }_{z} ( {yA}_{x} - {xA}_{y} ) - 2 ( x {\partial }_{y} - 7 {\partial }_{x} ) {A}_{z} ] , = {Ω}^{2} [ x ( {\partial }_{x} {A}_{z} - {\partial }_{z} {A}_{x} ) + y ( {\partial }_{y} {A}_{z} - {\partial }_{z} {A}_{y} ) - ( {x}^{2} {\partial }_{y}^{2} + {y}^{2} {\partial }_{x}^{2} - 2 xy {\partial }_{x} {\partial }_{y} ) {A}_{z} ] .$$

These equations may be solved with the following choice (Equation (A4)):

$${A}_{μ} = {e}^{i ( ω t - {k}_{σ} z )} ( 0 , 1 , i σ , α ( x + i σ y ) ) [ σ = \pm 1 ] \qquad ( A4 )$$

Indeed, plugging this choice in the first Maxwell equation, this becomes (using σ²=1) the following (Equation (A5)):

$$( x + i σ y ) [ α ω - i σ Ω ( {k}_{σ} - i α ) ] {k}_{σ} = 0 , \qquad ( A5 )$$

which is satisfied for k=ω−σΩ and α=iσΩ, confirming Equation (3). Similarly, the other three (spatial) Maxwell equations become (again using σ²=1) the following (Equation (A6)):

$${ω}^{2} - {k}_{σ}^{2} + i α {k}_{σ} - ω σ Ω = - ( x + i σ y ) [ α ω - ( i {k}_{σ} + α ) σ Ω ] y {k}_{σ} Ω , \qquad ( A6 )$$

$$- i σ ( {ω}^{2} - {k}_{σ}^{2} + i α {k}_{σ} - ω σ Ω ) = - ( x + i σ y ) [ α ω - ( i {k}_{σ} + α ) σ Ω ] x {k}_{σ} Ω ,$$

$$( x + i σ y ) [ {α ( ω - σ Ω )}^{2} - i σ Ω {k}_{σ} ( ω - σ Ω ) ] = 0 .$$

Verifiably, these equations are solved as well by the choice k=ω−σΩ, α=iσΩ.

### Section V: Generic Rotations

The description in this section provides a more general discussion of solutions for light propagating in rotating cavity setups. More specifically, the following description demonstrates that the phase shift of the transverse vector potentials considered hereinabove (and derived in detail in Section IV) still holds even when additional small rotations about axes orthogonal to the cavity symmetry axis are present.

For example, and without limitation, let the cavity symmetry axis be the z axis. For a generic rotation \vec{Ω}≡(Ωₓ,Ω_{y},Ω_{z}), the metric in the cavity-fixed frame may read as follows (Equation (B1)):

$${g}_{μ v} d {x}^{μ} d {x}^{v} = ( - 1 + {\vert \vec{Ω} ∧ \vec{r} \vert}^{2} ) d {t}^{2} + 2 ( \vec{Ω} ∧ \vec{r} ) \cdot d \vec{r} dt + {\vert d \vec{r} \vert}^{2} . \qquad ( B1 )$$

Working in the Weyl gauge, where the potential may be written as follows (Equation (B2)):

$${A}_{μ} = ( 0 , {A}_{x} , {A}_{y} , {A}_{z} ) ≡ ( 0 , \vec{A} ) , \qquad ( B2 )$$

one may perturb about the solution at Equation (2), which is exact when Ωₓ=Ω_{y}=0. Suppose that Ωₓ, Ω_{y} are treated as formal small parameters by sending Ω_{x,y}→ϵΩ_{x,y}, and that each component of the vector potential is written as a power series in ϵ. Substituting into Maxwell's equations (MEs), expanding in powers of ϵ, and satisfying the resulting equations that occur at each independent power of ϵ separately, allows derivation of a systematic perturbative expansion in powers of the formal small parameter ϵ. Moreover, consideration is given to the solution only close to the symmetry axis of the cavity, such that x, y→0 may be taken after substituting into MEs. Note: Of course, because MEs are differential equations, it is important for the purposes of checking if this is a good solution to keep terms ˜xⁿ, y^{m} until after substitution in the MEs. That is, to only set x, y→0 after such substitution.

The following perturbative expansion around the solution at Equation (2) results from this procedure (Equations (B3a) and (B3b)):

$${A}_{μ} = ( 0 , 1 , i σ , {A}_{z} ) {e}^{i ω t - ikz} ; k = ω - σ {Ω}_{z} \qquad ( B3a )$$

$${A}_{z} = i σ {Ω}_{z} ( x + i σ y ) + σ \frac{{Ω}_{x} + i σ {Ω}_{y}}{ω - σ {Ω}_{z}} \times [ 1 - i ( ω - σ {Ω}_{z} ) z - \frac{1}{4} ω ( 2 ω - σ {Ω}_{z} ) ( {x}^{2} + {y}^{2} ) ] . \qquad ( B3b )$$

For the avoidance of doubt, this solution is approximate in the following sense: If Ωₓ=Ω_{y}=0, this solution is exact. If Ωₓ, Ω_{y}≠0, then after substituting into MEs, this solution fails to satisfy MEs by terms that fall into the following three categories: (1) terms linear in Ωᵢ (i=x, y) [i.e., O(ϵ)] but which vanish at x=y=0; (2) terms quadratic in Ωᵢ, Ωⱼ (i=x, y) [i.e., O(ϵ²)] that vanish at x=y=0; and (3) terms quadratic in Ωᵢ, Ωⱼ (i=x, y) [i.e., O(ϵ²)] that do not vanish at x=y=0.

Spelling out the orders of these terms more explicitly, MEs are a series of second-order differential equations as far as the vector potentials are concerned. The leading terms that cancel out upon substitution of the correct dispersion relation are of O(ω², ωk, k²)˜O(ω²). To make dimensionless comparisons with these overall leading terms in MEs, therefore assume having divided MEs by ω² after substitution, and quote the orders of the leading remaining dimensionless corrections at O(ϵ, ϵ²) that fall into each of the three categories listed above, assuming that Ω_{x,y,z}<<ω. Category (1): terms of O(ωxᵢ²Ωⱼ, ωxᵢ²xⱼΩₖΩ_{z}, Ωᵢxⱼ) where i, j, k=x, y. Category (2): terms of O(ΩᵢΩⱼxₖz, ΩᵢΩⱼxₖ/ω, ωΩᵢΩⱼxₖx ₗz, ΩᵢΩⱼxₖxₗ) where i, j, k, l=x, y. Category (3): terms of O(Ωᵢ²z/ω, ΩᵢΩⱼ/ω²) where i, j=x, y.

Therefore, so long as xᵢΩⱼ<<1, Ω_{z}z<<1, Ω_{z}xᵢ<<1, Ωᵢz<<1, these terms are all automatically small, with the possible exception of terms of O(ωxᵢ²Ωⱼ) [category (1)] and those of O(ωxₖxₗ z ΩᵢΩⱼ)) [category (2)], which contain factors ˜ωz, ωxᵢ, which are in general large. To guarantee that these terms are also small, it suffices to impose one more requirement: ωΩᵢxⱼxₖ<<1 (Note: This is parametrically sufficient, but not necessary if the previous conditions are strongly numerically satisfied). Roughly, and up to numerical factors, this says that the transverse beam size should be parametrically smaller than the geometric mean of the EM wavelength and the inverse rotation rate about the x, y axes.

Under these conditions, which are all easy to satisfy, note that the A_{z} terms are also small corrections. Moreover, the transverse vector-field components Aₓ, A_{y} are not corrected at O(ϵ), and nor is the leading dispersion relation.

It follows that, as long as the mild conditions derived in this section hold, the approach advanced hereinabove will continue to apply even when Ω_{x,y}≠0, so long as these rotation rates are sufficiently small.

### Section VI: Inertial Frame and Rotation of the Apparatus

The analysis hereinabove is performed in a rotating frame. In this section, the system according to alternative embodiments of the present invention are described in the inertial frame by solving the ordinary field equations [symbol] _{μ}F^{μv}=0 for the inertial vector field A_{μ}, provided appropriate boundary conditions that describe a rotating source. In the case of a rotation around the \hat{z} axis, for a planar source of circularly polarized light localized at z=0 the field may take the form

$${A}_{μ} = {ϵ}_{μ} {e}^{i ( {ω}_{*} t - k z )} .$$

At the boundary z=0 the field may take the form

$${A}_{μ}^{B} ( t ) = {e}^{i ω t} ( 0 , {e}^{- i σΩ t} , i {σe}^{- i σ Ω t} , 0 )$$

and the boundary conditions may read as

$${A}_{μ} ( t , z = 0 ) = {A}_{μ}^{B} ( t ) .$$

This implies ω*=ω−σΩ so that the solution to the inertial equations of motion is as follows (Equation (C1)):

$${A}_{μ} = {e}^{i [ ( ω - σ Ω ) t - k z ]} ( 0 , 1 , i σ , 0 ) , k = ω - σ Ω . \qquad ( C1 )$$

This solution also satisfies the condition

$${A}_{μ} ( t , z ) = {A}_{μ}^{B} ( t - \frac{k}{{ω}_{*}} z ) ,$$

meaning that as the wavefront propagates, the polarization stays the same as it was at the moment of emission. The argument above shows that for circular polarization, regardless of the ratio Ω/ω, the resulting field may be expressed in terms of a single circularly polarized mode.

After the field has traveled for an interval L in the \hat{z} direction, two signals with opposite circular polarizations may be interfered to read the phase shift. This happens through a rotating apparatus, for which the basis of circularly polarized light is given by ϵ_{σ}=(0, e^{-iσΩt}, iσe^{-iσΩt},0). In this basis, the signal A_{μ}(t,L) will still have a polarization-dependent phase (Equation (C2)):

$${A}_{μ} = {ϵ}_{σ} {e}^{i ( ω t - k L )} = {ϵ}_{σ} {e}^{i ω ( t - L )} {e}^{i σ Ω L} . \qquad ( C2 )$$

This makes clear that reading the signal from a rotating laboratory does not remove the polarization-dependent phase shift. Indeed, while the time-dependent part of the phase shift between different polarizations is absorbed by the basis, the space-dependent relative phase accumulated over the interval L does not cancel. This is the same phase shift one sees in the non-inertial frame.

If the signal emitted was, for example, linearly polarized in the rotating frame, then the situation would be different. In the inertial frame the boundary condition would be

$${A}_{μ}^{B} ( t ) = {e}^{i ω t} ( 0 , cos ( Ω t ) , - sin ( Ω t ) , 0 ) ,$$

meaning that in this case the propagating field would be expressed as a linear combination of circularly polarized modes (Equation (C3)):

$$2 {A}_{μ} = {e}^{i [ ( ω - Ω ) t - {k}_{+} z ]} ( 0 , 1 , i , 0 ) + {e}^{i [ ( ω + Ω ) t - {k}_{-} z ]} ( 0 , 1 , - i , 0 ) , {k}_{\pm } = ω ∓ Ω . \qquad ( C3 )$$

This solution does again satisfy

$${A}_{μ} ( t , z ) = {A}_{μ}^{B} ( t - z ) ,$$

meaning that as a wavefront propagates it remains a linear combination of the two circular polarizations emitted initially. Because these have different dispersion relations, they accumulate a relative phase, resulting in a rotation of the plane of linear polarization.

While the above and attached descriptions contain much specificity, these should not be construed as limitations on the scope of any embodiment, but as exemplifications of the presented embodiments thereof. Many other modifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are, unless otherwise stated, used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the following claims and their legal equivalents, and not limited by the examples given. While the invention has been described and illustrated with reference to certain fabricated embodiments thereof, those skilled in the art will appreciate that various changes, modifications and substitutions can be made therein without departing from the spirit and scope of the invention. It is intended, therefore, that the invention be limited only by the scope of the claims which follow, and that such claims be interpreted as broadly as possible.

What is claimed is:

1. A rotation measurement system for a rotating body characterized by an axis of rotation; the system comprising:
a first light source configured to radiate a linearly polarized beam;
a sending beam splitter configured to split the linearly polarized beam into a first linearly polarized light wave and a second linearly polarized light wave;
a first sending polarizer configured to convert the first linearly polarized light wave to a first polarized state of a right circular type, to define a right-circularly polarized light wave;
a second sending polarizer configured to convert the second linearly polarized light wave to a second polarized state of a left circular type, to define a left-circularly polarized light wave;
a first cavity and a second cavity each characterized by a length L and a finesse F and each substantially axially aligned with the axis of rotation, wherein the first cavity is configured to store the right-circularly polarized light wave for a storage time ˜FL and the second cavity is configured to store the left-circularly polarized light wave for the storage time ˜FL;
a first receiving polarizer configured to receive the right-circularly polarized light wave from the first cavity after the storage time ˜FL and to convert the right-circularly polarized light wave to a first linearly polarized received wave, and a second receiving polarizer configured to receive the left-circularly polarized light wave from the second cavity after the storage time ˜F L and to convert the left-circularly polarized light wave to a second linearly polarized received wave;
a receiving beam splitter configured to combine the first and second linearly polarized received waves into an interfered beam; and
a detector configured to measure, in the interfered beam, a differential phase shift ΔΦ comprising a vibrational noise component of the rotating body.

2. The rotation measurement system according to claim 1, wherein the linearly polarized beam is of one of an optical frequency type and a radio frequency (RF) type.

3. The rotation measurement system according to claim 2, wherein the linearly polarized beam is of the RF type and the first cavity and the second cavity are each of a superconducting RF cavity type.

4. The rotation measurement system according to claim 2, wherein the linearly polarized beam is of the optical frequency type and the first cavity and the second cavity are each of a Fabry-Perot cavity type.

5. The rotation measurement system according to claim 2, wherein the linearly polarized beam is of the optical frequency type and the detector is of an optical interferometer type.

6. The rotation measurement system according to claim 1, further comprising a second light source configured to radiate a second linearly polarized beam; wherein the linearly polarized beam is characterized by a first frequency and the second linearly polarized beam is characterized by a second frequency not equal to the first frequency.

7. The rotation measurement system according to claim 1, wherein in at least one of the first sending polarizer, the second sending polarizer, the first receiving polarizer, the second receiving polarizer is of a quarter-wave plate type.

8. A precision gyroscope characterized by an axis of rotation, comprising:
a light source configured to radiate a plurality of linearly polarized beams;
a sending beam splitter configured to split each of the linearly polarized beams into a respective first linearly polarized light wave and a respective second linearly polarized light wave;
a first sending polarizer configured to convert the respective first linearly polarized light wave to a first polarized state of a right circular type, to define a respective right-circularly polarized light wave;
a second sending polarizer configured to convert the respective second linearly polarized light wave to a second polarized state of a left circular type, to define a respective left-circularly polarized light wave;
a first cavity and a second cavity each characterized by a length L and a finesse F and each substantially axially aligned with the axis of rotation, wherein the first cavity is configured to store the respective right-circularly polarized light wave for a storage time ˜FL and the second cavity is configured to store the respective left-circularly polarized light wave for the storage time ˜FL;
a first receiving polarizer configured to receive the respective right-circularly polarized light wave from the first cavity after the storage time ˜FL and to convert the respective right-circularly polarized light wave to a respective first linearly polarized received wave, and a second receiving polarizer to receive the respective left-circularly polarized light wave from the second cavity after the storage time ˜FL and to convert the respective left-circularly polarized light wave to a respective second linearly polarized received wave;
a receiving beam splitter configured to combine the respective first and second linearly polarized received light waves into a respective interfered beam; and
a detector configured to measure, in the respective interfered beam, a respective differential phase shift ΔΦ comprising a vibrational noise component of the precision gyroscope.

9. The precision gyroscope according to claim 8, wherein at least one of the plurality of linearly polarized beams is of one of an optical frequency type and a radio frequency (RF) type.

10. The precision gyroscope according to claim 9, wherein at least one of the plurality of linearly polarized beams is of the RF type and the first cavity and the second cavity are each of a superconducting RF cavity type.

11. The precision gyroscope according to claim 9, wherein at least one of the plurality of linearly polarized beams is of the optical frequency type and the first cavity and the second cavity are each of a Fabry-Perot cavity type.

12. The precision gyroscope according to claim 9, wherein at least one of the plurality of linearly polarized beams is of the optical frequency type and the detector is of an optical interferometer type.

13. The precision gyroscope according to claim 8, wherein the plurality of linearly polarized beams further comprises a first linear polarized beam characterized by a first frequency and a second linearly polarized beam characterized by a second frequency not equal to the first frequency.

14. The precision gyroscope according to claim 8, wherein in at least one of the first sending polarizer, the second sending polarizer, the first receiving polarizer, the second receiving polarizer is of a quarter-wave plate type.

15. A method of measuring rotation of a rotating body characterized by an axis of rotation, and using:
a first light source,
a sending beam splitter,
a first sending polarizer and a second sending polarizer,
a first cavity and a second cavity each characterized by a length L and a finesse F and each axially aligned with the axis of rotation,
a first receiving polarizer and a second receiving polarizer,
a receiving beam splitter, and
a detector;
the method comprising the steps of:
radiating, using the first light source, a linearly polarized beam;
splitting, using the beam splitter, the linearly polarized beam into a first linearly polarized light wave and a second linearly polarized light wave;
converting, using the first sending polarizer, the first linearly polarized light wave to a first polarized state of a right circular type, to define a right-circularly polarized light wave;
converting, using the second sending polarizer, the second linearly polarized light wave to a second polarized state of a left circular type, to define a left-circularly polarized light wave;
storing, using the first cavity, the right-circularly polarized light wave for a storage time ˜FL and, using the second cavity, the left-circularly polarized light wave for the storage time ˜FL;
receiving, using the first receiving polarizer, the right-circularly polarized light wave from the first cavity after the storage time ˜FL;
converting, using the first receiving polarizer, the right-circularly polarized light wave to a first linearly polarized received wave;
receiving, using the second receiving polarizer, the left-circularly polarized light wave from the second cavity after the storage time ˜FL;
converting, using the second receiving polarizer, the left-circularly polarized light wave to a second linearly polarized received wave;
combining, using the receiving beam splitter, the first and second linearly polarized received waves into an interfered beam; and
measuring, using the detector, in the interfered beam a differential phase shift ΔΦ comprising a vibrational noise component of the rotating body.

16. The method of measuring rotation according to claim 15, wherein the linearly polarized beam is of one of an optical frequency type and a radio frequency (RF) type.

17. The method of measuring rotation to claim 16, wherein the linearly polarized beam is of the RF type and the first cavity and the second cavity are each of a superconducting RF cavity type.

18. The method of measuring rotation according to claim 16, wherein the linearly polarized beam is of the optical frequency type and the first cavity and the second cavity are each of a Fabry-Perot cavity type.

19. The method of measuring rotation according to claim 16, wherein the linearly polarized beam is of the optical frequency type and the detector is of an optical interferometer type.

20. The method of measuring rotation according to claim 15, further comprising the step of radiating, using a second light source, a second linearly polarized beam; wherein the linearly polarized beam is characterized by a first frequency and the second linearly polarized beam is characterized by a second frequency not equal to the first frequency.
